(19) United States
(12) Patent Application Publication
(10) Pub. No.: US 2008/0142332 A1
(43) Pub. Date: Jun. 19, 2008

(54) Electromagnetic clutch device and method for manufacturing same

(76) Inventors: Takanobu Koyama, Nagano-ken (JP); Daisuke Hashimoto, Nagano-ken (JP)

Correspondence Address: MUIRHEAD AND SATURNELLI, LLC, 200 FRIBERG PARKWAY, SUITE 1001, WESTBOROUGH, MA, 01581, US

(21) Appl. No.: 12/001,122

(22) Filed: Dec. 10, 2007

(30) Foreign Application Priority Data
Dec. 15, 2006 (JP) 2006-338592

(51) Int. Cl. F16D 27/06; H01F 7/06

(52) U.S. Cl. 192/84.961; 29/602.1

(57) ABSTRACT

An inexpensive electromagnetic clutch device with high precision, which can be manufactured by a simple method, is provided, which clutch device includes: a base member for supporting an entire clutch; a shaft securely fixed to the base member; a rotor arranged onto the shaft, rotatably relative to the base member around the shaft; an electromagnetic coil for causing an electromagnetic force on the rotor when energized; an armature attracted to the rotor and frictionally coupled with the rotor when electromagnetic coil is energized and a torque transmission member coupled to the armature and a member to be driven.

### BACKGROUND OF THE INVENTION

1. Field of the Invention

The present invention relates to an electromagnetic clutch device that is capable of switching a transmission state and a non-transmission state of a driving force by means of an electromagnetic force and a method for manufacturing the electromagnetic clutch device.

2. Description of the Related Art

Conventionally, there have been known electromagnetic clutch devices which are capable of switching a transmission state and a non-transmission state of a driving force.

In the electromagnetic clutch device described in Patent Document 1 or Patent Document 2 below referred to, when a rotational driving force is transmitted in a transmission state of a driving force, the rotational driving force is adapted to be transmitted via a shaft that serves as a rotary shaft.

In other words, the shaft of such electromagnetic clutch device is a part that serves as a route for inputting/outputting a transmission torque to the other parts. And the shaft is fixed to a rotor rotated by means of a motor such as an external motor or a member to be transmitted by means of the rotational driving force and rotated together with these members in the transmission state of the driving force.
Patent Document 1: Japanese Patent Application Laid-open No. 2002-327576
Patent Document 2: Japanese Patent Application Laid-open No. 2005-232918

In the conventional clutch devices as described above, there has been a demand for precision machining by the incorporation of a bearing, relative to the shaft and use of a high strength material that is endurable to a torque transmission force.

In addition, in consideration of a state in which the rotor is rotated by means of the driving force such as a motor and an armature is frictionally coupled with the rotor by means of energizing an electromagnetic coil, and then, is rotated by means of a rotational force of the rotor being transmitted to a member to be driven with the shaft, it is necessary that the armature and the shaft are mutually movable in an axial direction and can be moved together in a rotational direction. Thus, there has been a problem that the shaft needs to have a specific structure such as serration, resulting in high machining cost.

Further, in the electromagnetic clutch device, a housing is defined as a reference for positioning between the clutch device and a slave device, whereas in the clutch, the shaft is defined as a center reference. Thus, in the case where the shaft rotates as in the conventional electromagnetic clutch device, in order to support the shaft that serves as a rotational member, there is a need for a structure with high precision such that de-centering between an input and an output in the slave device and the clutch does not occur. Therefore, when the shaft is incorporated in and fixed to the housing, a large number of small parts such as snap ring and shims are required to diminish a thrust backlash, and the assembling man-hour and inspection man-hour are increased.

### SUMMARY OF THE INVENTION

The present invention has been made in view of the above problems. It is an object of the present invention to provide an inexpensive electromagnetic clutch device with high precision, which can be manufactured by a simple method.

In order to achieve the object described above, according to one aspect of the present invention, an electromagnetic clutch device comprises: a base member for supporting an entire clutch; a shaft securely fixed to the base member; a rotor arranged onto the shaft rotatably relative to the base member around the shaft; an electromagnetic coil for causing an electromagnetic force on the rotor when energized; an armature attracted to the rotor and frictionally coupled to the rotor when the electromagnetic coil is energized; and a torque transmission member coupled to the armature and a member to be driven.

In the aspect of the present invention, an inexpensive electromagnetic clutch device with high precision can be provided, which can be manufactured by means of a simple method.

In other words, the electromagnetic clutch device of the present invention is structured such that the shaft is fixed to the housing to form an integral part and the rotational driving force is not transmitted via the shaft. Thus, the electromagnetic clutch device can be configured inexpensively in terms of the number of parts, the cost of a material of the shaft, and shaft machining.

In addition, in manufacture, it is sufficient that an integral part of the shaft and the housing is prepared and remaining parts are mounted in a unidirectional stacking manner, thus making it possible to achieve efficient and easy assembling.

Further, according to the aspect of the present invention, the housing and the shaft are integrally structured, thus making it possible to easily diminish an inclination of the shaft of the electromagnetic clutch device merely by preventing the inclination when the shaft is fixed to the housing.

Furthermore, according to the aspect of the present invention, the housing and the shaft are integrally structured, thus making it possible to precisely adjust the positioning or inclination between each of them and the slave device.

Further objects and advantages of the invention will be set forth in the description which follows, and in part will become more apparent from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate preferred embodiments of the present invention and serve to explain the principle of the present invention.

FIG. 1 is a perspective view showing an appearance of one embodiment of an electromagnetic clutch device according to the present invention;

FIG. 2 is a sectional view taken along line II-II of FIG. 1;

FIG. 3 is an exploded perspective view illustrating a manufacturing process for the electromagnetic clutch device shown in FIG. 1;

FIG. 4 is an exploded perspective view illustrating a manufacturing process that follows the state shown in FIG. 3;

FIG. 5 is a perspective view showing an example of a configuration for rotating a rotor relative to the electromagnetic clutch device shown in FIG. 1 and showing a state in which one example of a member to be driven is mounted; and

FIG. 6 is a sectional view taken along line VI-VI of FIG. 5.

### DETAILED DESCRIPTION OF THE INVENTION

Reference will now be made in detail to the preferred embodiments of the invention as illustrated in the accompanying drawings, in which like reference numerals designate like or corresponding parts.

Hereinafter, the preferred embodiments of the present invention will be described with reference to the accompanying drawings.

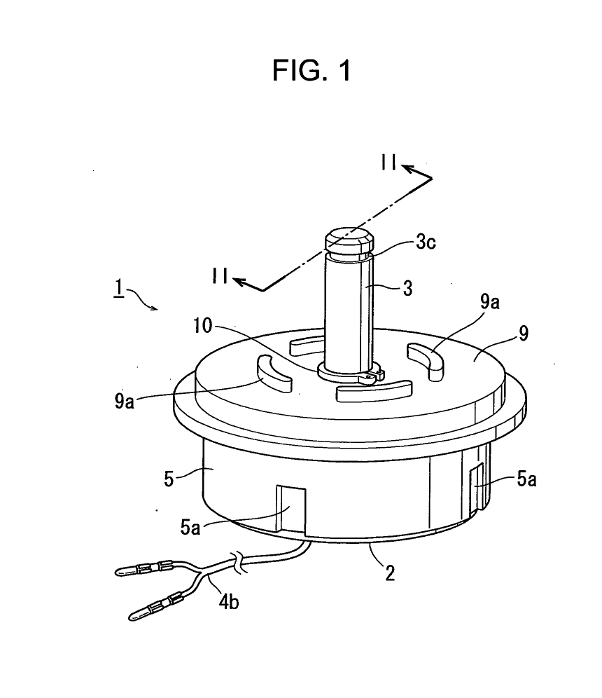

FIG. 1 is a perspective view showing an appearance of one embodiment of an electromagnetic clutch device according to the present invention.

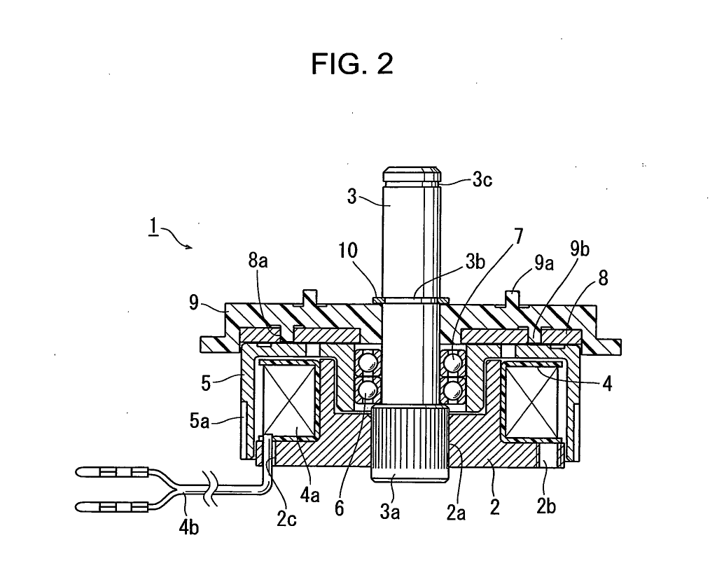

FIG. 2 is a sectional view taken along line II-II of FIG. 1.

As shown in FIGS. 1 and 2, an electromagnetic clutch device 1 of the embodiment includes a coil bobbin 4 in which a shaft 3 is fixed to a housing 2 and an electromagnetic coil 4a is wound therearound; a rotor 5 that is rotated by means of a motor described later; an armature 8 that is attracted to the rotor 5 by means of an electromagnetic force; and a torque transmission member 9 engaged with the armature 8.

The housing 2 functions as a base member for supporting the entire electromagnetic clutch device 1, and is formed of a magnetic material such as carbon steel, for example. A shaft insertion hole 2a is provided at a center part of the housing 2.

The shaft 3 is formed of a magnetic material such as carbon steel, for example. An end part 3a of the shaft is formed in a knurled shape (notched shape), and the end part is press-fitted into the hole 2a at the center part of the housing 2, whereby the housing 2 and the shaft 3 are fixed to each other, and can be handled as an integral part.

A mount hole 2b is provided in the housing 2. The housing 2 may be fixed to a slave device by means of a set screw or the like using this mount hole 2b. A wire through hole 2c is also provided for leading a wire 4b for energizing the electromagnetic coil 4a.

The coil bobbin 4 around which the electromagnetic coil 4a is wound is inserted into the housing 2. Then, rotor 5 having a U-shaped cross section is disposed on the coil bobbin 4. The electromagnetic coil 4a is formed of a conductive material such as a copper wire, for example, and the coil bobbin 4 is formed of a resin, for example. The rotor 5 is formed of a magnetic material such as carbon steel.

Bearings 6 and 7 are press-fitted into a hole at the center part of the rotor 5. The bearings 6 and 7 are formed in a ring shape, and the shaft 3 is inserted into the hole at the center part thereof, whereby the rotor 5 is rotatable relative to the shaft 3. The housing 2 and the rotor 5 are disposed to surround the electromagnetic coil 4a, wherein the rotor 5 is disposed with a gap relative to another member (the housing 2 or the coil bobbin 4) without contact with a member other than the bearings 6 and 7, so as to enable smooth rotation.

A groove 5a is provided at an outer circumferential surface of the rotor 5, and a worm wheel described later is provided at the outer circumference of the rotor 5, and then, is engaged with this groove 5a, whereby a rotation of a motor is transmitted to the worm wheel via a worm gear described later and the rotor 5 is rotated thereby.

The housing 2 and the rotor 5 form a magnetic path through which a magnetic flux generated by the electromagnetic coil 4a passes. Thus, in order to reduce magnetic loss, it is desirable that a gap between the housing 2 and the rotor 5 be narrow. However, according to the present embodiment, the gap between the housing 2 and the rotor 5 can be designed in consideration of only a backlash caused by the bearings 6 and 7, thus making it possible to achieve such a narrow gap and reduce the loss.

The armature 8 is formed of a material such as an iron material (SPCC, for example) which is magnetically attracted by means of an electromagnetic force. The torque transmission member 9 is formed of a resin, for example.

The armature 8 is provided on the rotor 5. When the electromagnetic coil 4a is deenergized, the armature 8 is not attracted to the rotor 5, so that the armature is not frictionally coupled therewith, and is rotatable with slippage to each other.

The armature 8 is provided with a slit 8a into which a protrusion 9b provided at a lower part of the torque transmission member 9 is inserted. The torque transmission member 9 is movable in a vertical direction relative to the armature 8 by means of removable insertion of the protrusion 9b relative to this slit 8a. With the protrusion 9b engaged with the slit 8a, however, the armature 8 and the torque transmission member 9 are linked with each other in a rotational direction.

In the present embodiment, the groove 3b is provided on the shaft 3 in order to prevent the shaft 3 from coming off in a state where the torque transmission member 9 is inserted into the shaft 3, and a first locking ring 10 engaged with this groove 3b is provided.

When the electromagnetic coil 4a is energized, the rotor 5 attracts the armature 8 by means of an electromagnetic force, and then, both of them are frictionally coupled with each other. As a result, when the rotor 5 rotates, the armature 8 rotates together with the rotor 5, and the torque transmission member 9 also rotates together with one another. A protrusion 9a is provided on a top face of the torque transmission member 9, and the rotation of the rotor 5 is transmitted via the protrusion 9a to a member to be driven. A pulley described later is exemplified as a member to be driven.

A groove 3c is provided on the shaft 3 in order to prevent the pulley from coming offslippage in a state where the pulley is inserted into the shaft 3, and a second slippage proof ring described later is mounted in this groove 3c, thereby making it possible to integrate constituent elements including the pulley.

Now, a method for manufacturing an electromagnetic clutch device 1 according to the present embodiment will be described with reference to the accompanying drawings.

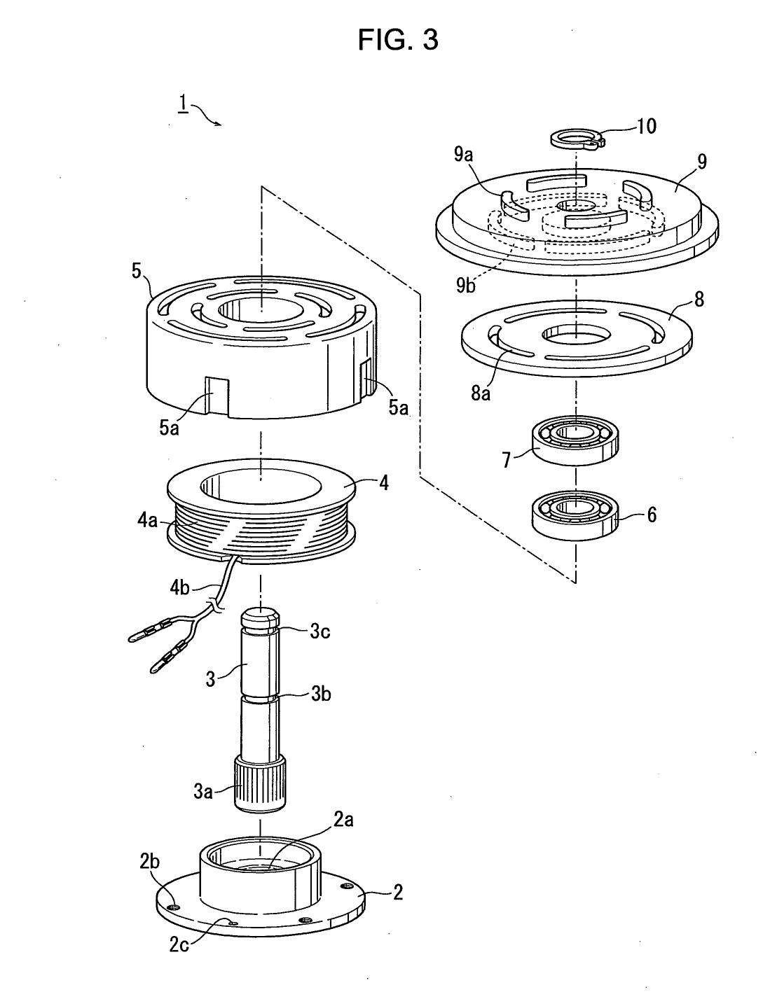

FIG. 3 is an exploded perspective view illustrating a manufacturing process for the electromagnetic clutch device shown in FIG. 1.

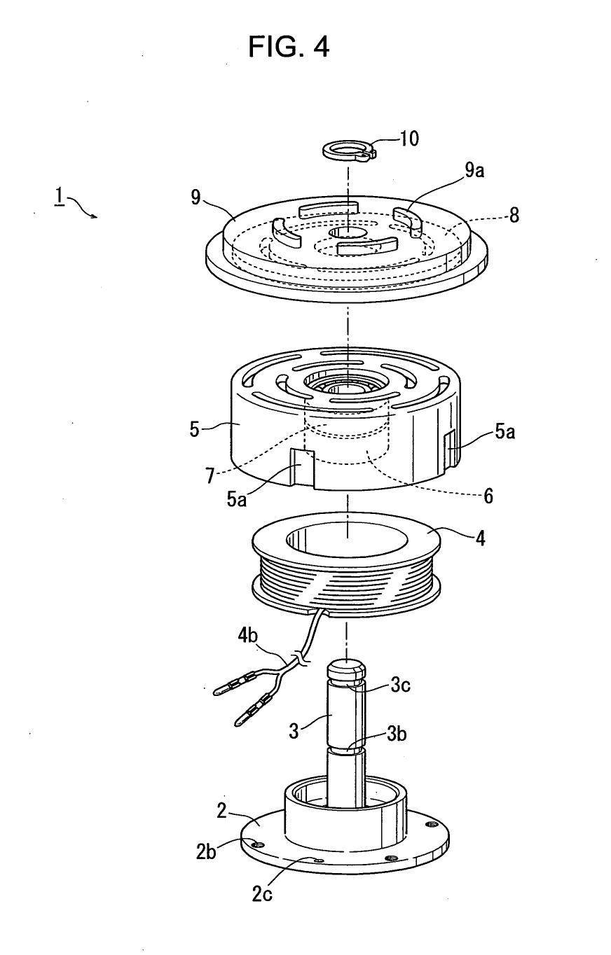

FIG. 4 is also an exploded perspective view illustrating a manufacturing process that follows the process shown in FIG. 3.

Referring to FIG. 3, an electromagnetic clutch device 1 includes: a housing 2; a shaft 3; a coil bobbin 4 with an electromagnetic coil 4a wound therearound; a rotor 5; bearings 6 and 7; an armature 8; a torque transmission member 9; and a first locking ring 10.

In manufacture of this electromagnetic clutch device 1, first, the electromagnetic coil 4a is wound around the coil bobbin 4. Separately the shaft 3 is press-fitted to the housing 2 to form a coupling member of the housing 2 and the shaft 3. Then the bearings 6 and 7 are press-fitted into the rotor 5 as shown in FIG. 4.

Then, the coil bobbin 4 with the electromagnetic coil 4a wound therearound is inserted into the shaft 3 fixed to the housing 2 over the top of the shaft 3, and a wire 4b for energizing the electromagnetic coil 4a is led out from a wire through-hole 2c of the housing 2.

Next, the rotor 5 is inserted so as to rotate relative to the shaft 3 via the bearings 6 and 7. The armature 8 and the torque transmission member 9 are inserted into the shaft 3 in sequential order from the top thereof. Lastly, the first locking ring 10 is mounted in the groove 3b of the shaft 3. Thus the manufacture of the electromagnetic clutch device 1 is completed.

As described above, according to the present embodiment, the housing 2 is placed on an assembling base and members have only to be inserted from the top thereof without changing the orientation of the housing 2 at all, thus making it possible to carry out efficient and easy assembling.

Next, with reference to the accompanying drawings, a description will be given with respect to a state where a worm wheel and a worm gear as constituent elements for rotating the rotor 5 are mounted onto the electromagnetic clutch device 1 shown in FIG. 1, and further, a pulley as a member to be driven is mounted.

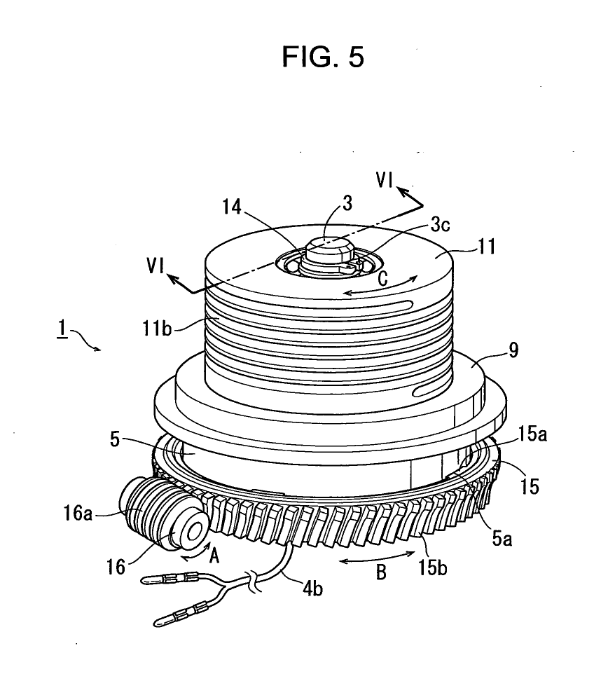

FIG. 5 is a perspective view showing an example of a configuration for rotating a rotor relative to the electromagnetic clutch device shown in FIG. 1 and showing a state in which one example of a member to be driven is mounted.

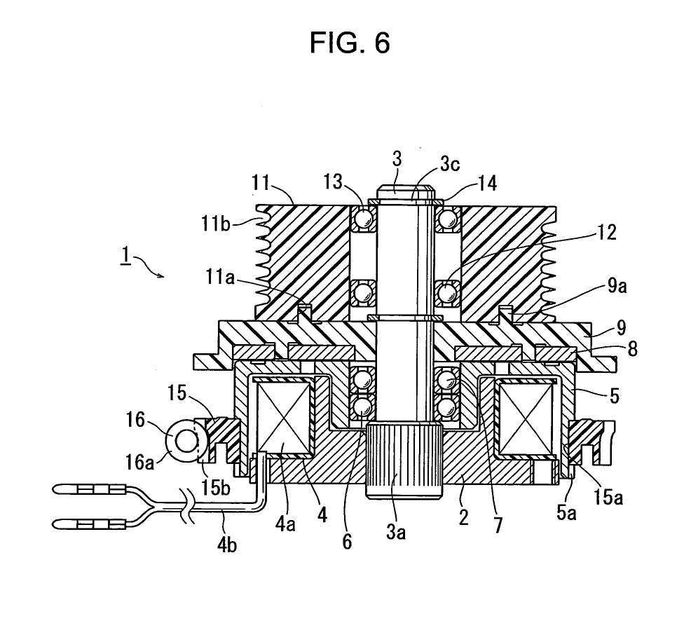

FIG. 6 is a sectional view taken along line VI -VI of FIG. 5.

A worm wheel 15 is provided with a protrusion 15a on an inner circumferential surface thereof which is engaged with a groove 5a provided on an outer circumferential surface of a rotor 5.

A protrusion 15b is provided on the entire of the outer circumferential surface of the worm wheel 15, and a groove 16a of a worm gear 16 is engaged with the protrusion 15b.

The worm gear 16 is fixedly provided not to move relative to a housing 2. If a motor (not shown) rotates the worm gear 16 in the direction indicated by arrow A in FIG. 5, this rotation is transmitted to the worm wheel 15 by means of the groove 16a and the protrusion 15b, and then, the worm wheel 15 is caused to rotate relative to the housing 2 in the direction indicated by arrow B in FIG. 5.

The rotation of the worm wheel 15 is further transmitted to the rotor 5 by means of the protrusion 15a and the groove 5a, whereby the rotor 5 is rotated.

A pulley 11 is inserted to rotate relative to a shaft 3 via bearings 12 and 13 while the bearings 12 and 13 are press-fitted into an inner circumferential surface thereof.

After the pulley 11 has been inserted onto the shaft 3, a second locking ring 14 is mounted in a groove 3c of the shaft 3. Thus constituent elements including the pulley are integrated with each other.

The pulley 11 is provided with a groove 11a which is engaged with a protrusion 9a on a top face of a torque transmission member 9. Rotation of the torque transmission member 9 caused by rotation of the rotor 5 is transmitted to the pulley 11 by means of the protrusion 9a and the groove 11a, whereby the pulley 11 is caused to rotate in the direction indicated by arrow C in FIG. 5.

The pulley 11 is provided with a groove 11b on an outer circumferential surface thereof. When the pulley 11 rotates in the direction indicated by arrow C, a wire (not shown) is wound along the groove 11b, thereby drawing an object connected to the other end of the wire.

In the embodiment described above, while the housing 2 functions both as a base member mounted onto a slave device and as a magnetic path of a magnetic circuit, the present invention is not limited thereto. Using a stator yoke having a U-shaped cross section in combination with a rotor having a U-shaped cross section, even if the base member is structurally configured as a member independent of the stator yoke, the present invention can be applied by securely fixing the base member and a shaft.

Therefore, the invention in its broader aspect is not limited to the specific details and representative embodiments shown and described herein. Accordingly, various modifications may be made without departing from the spirit or scope of the general inventive concept as defined by the appended claims and their equivalents.

What is claimed is:

1. An electromagnetic clutch device, comprising:
a base member for supporting an entire clutch;
a shaft securely fixed to the base member;
a rotor arranged onto the shaft rotatably relative to the base member around the shaft;
an electromagnetic coil for causing an electromagnetic force on the rotor when energized;
an armature attracted to the rotor and frictionally coupled with the rotor when the electromagnetic coil is energized; and
a torque transmission member coupled to the armature and a member to be driven.

2. A method for manufacturing an electromagnetic clutch device, comprising the steps of:
fixing a shaft at one side of a base member for supporting an entire clutch to form a coupled member of the base member and the shaft; and
arranging an electromagnetic coil, a rotor and an armature in this order from one side of the shaft of the coupled member to form the electromagnetic clutch device.
